(19) United States
(12) Patent Application Publication
(10) Pub. No.: US 2007/0014602 A1
(43) Pub. Date: Jan. 18, 2007

(54) Fixing device and image forming apparatus having the same

(75) Inventor: Dong-jin Seol, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/483,663

(22) Filed: Jul. 11, 2006

(30) Foreign Application Priority Data
Jul. 16, 2005 (KR) 2005-64552

(51) Int. Cl. G03G 15/20

(52) U.S. Cl. 399/329; 399/333

(57) ABSTRACT

A fixing device and an image forming apparatus including the fixing device includes a core pipe which is made to be thin to a predetermined thickness or less and having a strength that increases while being aging-treated based on the use time of the fixing device, and a fixing belt to enlarge a fixing Thus, a warming-up time is shortened, a print speed increases, and a fixing quality is improved.

### CROSS-REFERENCE TO RELATED APPLICATIONS

This application claims the priority of Korean Patent Application No. 10-2005-0064552 filed with the Korea Industrial Property Office on Jul. 16, 2005, the disclosure of which is incorporated herein in its entirety by reference.

### BACKGROUND OF THE INVENTION

1. Field of the Invention

The present general inventive concept relates to a fixing device and an image forming apparatus including the fixing device, and more particularly, to a fixing device to fix a toner image transferred to a printing medium by applying heat and pressure thereto, and an image forming apparatus including the fixing device.

2. Description of the Related Art

In general, an electrophotographic type image forming apparatus, such as a printer, a copier, and a multifunction printer, includes a fixing device which fixes a toner image, transferred to a printing medium such as a paper and an OHP film, by high temperature and pressure. A heating roller heats the printing medium to a temperature required to fix the toner image of the printing medium. A pressing roller, which presses and contacts the heating roller, presses the printing medium at a pressure required to fix the toner image. A fixing nip with a predetermined length is formed in a position at which the heating roller and the pressing roller contact each other, and the fixing is performed while the printing medium passes through the fixing nip.

In a case where the contact position of the heating roller and the pressing roller has only rigid characteristics, a mechanical impact or a fixing failure may occur when irregularities exist at the surface of the printing medium passing through the fixing nip or when sizes of toner powders are not uniform. To prevent the fixing failure and to maintain the contact pressure and the length of the fixing nip at a predetermined value, outer circumferences of the heating roller and the pressing roller are formed with an elastic layer made of synthetic resin, rubber, or the like. The heating roller and the pressing roller contact each other at a predetermined high pressure to guarantee the fixing pressure and the length of the fixing nip. In a case where the printing medium passes the fixing device in a state in which the fixing device is not sufficiently heated to a predetermined high temperature, the fixing failure is generated. The high pressure and the high temperature at the outer circumference of the heating roller and the pressing roller may shorten a life-span of the elastic layer.

On the other hand, the heating roller and the pressing roller need to have a sufficient strength to prevent a variance of the heating roller and pressing roller in dimension due to the high temperature and the high pressure. In general, the inner circumferences of the heating roller and the pressing roller are formed with a metallic pipe having a sufficient thickness to prevent the dimensional variance.

To increase a printing speed, a warming-up time needs to be shortened. However, because thermal capacities of the synthetic resin and the rubber of the elastic layer, the thick metallic pipe, or the like are large, the warming-up time for heating the fixing device to the predetermined high temperature is lengthened. Therefore, there is a need to provide a fixing device in which the warming-up time is shortened by decreasing the thermal capacities of the heating roller and the pressing roller. In addition, there is a need to prevent the high temperature deterioration of the elastic layer, and to improve fixing characteristics of the fixing roller through the extension of the fixing nip and reinforcement of the fixing roller's rigidity.

### SUMMARY OF THE INVENTION

The present general inventive concept provides a fixing device in which a warming-up time to heat the fixing device to a predetermined temperature required for a fixing is shortened, and a high temperature deterioration of an elastic layer and a fixing failure are prevented, and which is suitable for manufacturing a high-speed image forming apparatus, and an image forming apparatus including the fixing device.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a fixing device including a heat source to generate heat to fuse a toner image adhering to a printing medium, a heating roller including a core pipe heated by the heat source and an elastic layer provided to an outer circumference of the core pipe, and a pressing roller to press the printing medium on the outer circumferential surface of the heating roller, in which the core pipe is aging-treated at a fixing temperature while being used for the fixing device, so that a strength thereof increases.

The foregoing and/or other aspects and utilities of the present general inventive concept may also be achieved by providing an electrophotographic type image forming apparatus having a print unit to control a toner image to adhere to a printing medium through an electrophotographic method, and a fixing device to fuse the toner image to the printing medium, in which the fixing device includes a heat source to generate a heat to fuse the toner image adhering to the printing medium, a heating roller including a core pipe heated by the heat source and an elastic layer provided to an outer circumference of the core pipe, and a pressing roller to press the printing medium on the outer circumferential surface of the heating roller, and the core pipe is aging-treated at a fixing temperature while used for the fixing device, so that a strength thereof increases.

A material of the core pipe may be one of a maraging steel, a 2000-series aluminum alloy, a 6000-series aluminum alloy, and a 7000-series aluminum alloy.

A thickness of the core pipe may be 1 mm or less.

The fixing roller may further include a release layer provided to an outer circumference of the elastic layer to prevent the toner image from adhering to the heating roller.

The fixing device may further include a fixing belt which is pressed by the pressing roller, forms a fixing nip together with the outer circumferential surface of the heating roller, and moves in circulation.

The fixing device may further include an auxiliary pressing member to press the fixing belt together with the pressing roller toward the heating roller to make the fixing belt contact the heating roller.

The auxiliary pressing member may further include a supporting member which is elastically biased in a direction of the fixing belt, and an elastic member which is laminated on the supporting member to slidingly support the fixing belt.

The auxiliary pressing member may further include an auxiliary pressing roller which is elastically biased in a direction of the fixing belt to support the fixing belt while rotating.

The foregoing and/or other aspects and utilities of the present general inventive concept may also be achieved by providing an image forming apparatus, including a heating roller formed with a core pipe having a material to undergo heat treatment at a work temperature of the image forming apparatus so that the core pipe of the heating roller approaches a maximum hardness as the image forming apparatus nears the end of an image forming apparatus work life.

The foregoing and/or other aspects and utilities of the present general inventive concept may also be achieved by providing a method of hardening a core pipe of a heating roller in an image forming apparatus, including heating the heating roller to a work temperature where a hardening temperature of a core pipe material approximates the work temperature.

The foregoing and/or other aspects and utilities of the present general inventive concept may also be achieved by providing an image fixing apparatus, including a main body, an image forming unit disposed in the main body to form an image on a printing medium, and a fixing device having a heating roller to generate heat to fuse the image on the printing medium and to be age-treated by the generated heat.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a side sectional view illustrating a single-color image forming apparatus according to an embodiment of the present general inventive concept;

FIG. 2 is a side sectional view illustrating a color image forming apparatus according to an embodiment of the present general inventive concept;

FIG. 3 is a side sectional view illustrating a fixing device according to an embodiment of the present general inventive concept;

FIG. 4 is a side sectional view illustrating a fixing device according to an embodiment of the present general inventive concept; and

FIGS. 5A to 5C are graphs illustrating a relationship between an aging treatment and strength according to a type of a material of a core pipe according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

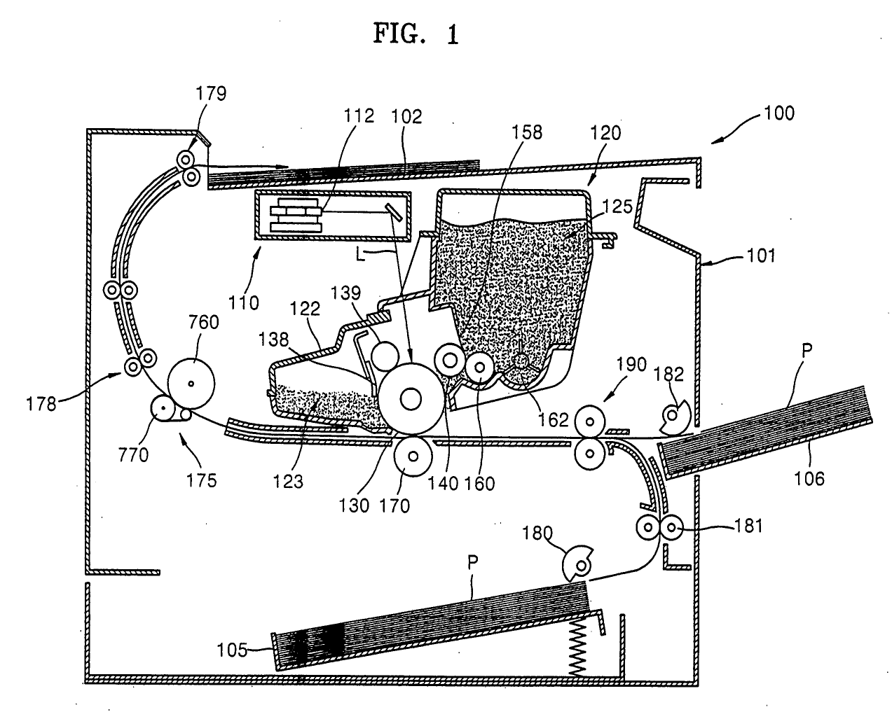

FIG. 1 is a side sectional view illustrating a single-color electrophotographic type image forming apparatus 100 according to an embodiment of the present general inventive concept. The image forming apparatus 100 includes a print unit which transfers a toner image onto a printing medium P, and a fixing device 175 which fixes the toner image. The print unit includes an image forming apparatus main body 101, a light scanning unit 110, and a developing cartridge 120.

The light scanning unit 110 scans light L corresponding to image information onto a photo-sensitive member 130 and forms an electrostatic latent image on an outer circumferential surface of the photo-sensitive member 130. The light scanning unit 110 includes a light source (not shown) for irradiating a laser beam, and a beam-biasing unit 112 for biasing the beam irradiated from the light source.

The developing cartridge 120 is detachably disposed inside the image forming apparatus main body 101. The developing cartridge 120 includes a developing roller 140 and the photo-sensitive member 130 facing the developing roller 140. A developing cartridge housing 122 forms an exterior of the developing cartridge 120. The inside of the developing cartridge housing 122 is provided with the photo-sensitive member 130, a charge roller 139, a cleaning member 138, the developing roller 140, a toner layer regulation member 158, a supply roller 160, and an agitator 162. Further, a waste toner reservoir 123 which stores a waste toner separated from the photo-sensitive member 130 by the cleaning member 138, and a toner reservoir 125 which stores the toner are provided in the developing cartridge housing 122. The developing cartridge 120 is replaced with a new developing cartridge 120 when the toner stored in the toner reservoir 125 is used up.

The photo-sensitive member 130 is so provided that a partial portion of an outer circumferential surface thereof is exposed, and rotates in a predetermined direction. A photo-conductive material layer is coated on the outer circumferential surface of a cylindrical drum of the photo-sensitive member 130 by a deposition method or the like. The photo-sensitive member 130 is charged with a predetermined potential by the charge roller 139, and the electrostatic latent image corresponding to an image to be printed is formed at the outer circumferential surface of the photo-sensitive member 130 by the light L irradiated by the light scanning unit 110.

The developing roller 140 reserves the toner of a solid powder phase and supplies the toner to the electrostatic latent image formed at the photo-sensitive member 130 to develop the electrostatic image into the toner image. A developing bias voltage for supplying the toner to the photo-sensitive member 130 is applied to the developing roller 140. The outer circumferential surfaces of the developing roller 140 and the photo-sensitive member 130 contact each other to form a developing nip, or the outer circumferential surfaces thereof are separated from each other to form a developing gap. The developing nip or the developing gap must be formed to a predetermined size along the axes of the developing roller 140 and the photo-sensitive member 130.

The supply roller 160 supplies the toner to the developing roller 140 such that the toner adheres to the developing roller 140. The agitator 162 agitates the toner so that the toner in the toner reservoir 125 does not become hard and supplies the toner toward the supply roller 160. The toner layer regulation member 158 regulates the thickness of the toner adhering to the outer circumferential surface of the developing roller 140.

The cleaning member 138 is provided into the developing cartridge housing 122, and contacts the photo-sensitive member 130 with a predetermined pressure to scrape the toner remaining on the photo-sensitive member 130 after a portion of the toner has been transferred.

A transfer roller 170 faces the outer circumferential surface of the photo-sensitive member 130, and applies a transfer bias voltage having a polarity opposite to that of the toner image to the printing medium P so that the toner image developed to the photo-sensitive member 130 is transferred to the printing medium P. The toner image is transferred to the printing medium P due to an electrostatic power and a mechanical contact pressure acting between the photo-sensitive member 130 and the transfer roller 140. The developing cartridge 120 and the transfer roller 140 may be referred to as an image forming unit to form the toner image to the print medium P.

The fixing device 175 includes a heating roller 760 and a pressing roller 770 facing the heating roller 760, and fixes the toner image to the printing medium P by applying heat and pressure to the toner image transferred to the printing medium P.

A de-curling part 178 removes a curl of the printing medium P, which is generated due to the heat of the fixing device 175. A paper discharge roller 179 discharges the printing medium P, in which the fixing has finished, to an outside of the image forming apparatus 100. The printing medium P discharged from the image forming apparatus 100 is loaded on a paper discharge tray 102.

A moving path of the printing medium P is as follows. The image forming apparatus 100 includes first and second paper feed cassettes 105 and 106 in which the printing medium P is loaded. Pick-up rollers 180 and 182 pick up and carry the loaded printing medium P one by one. A transport roller 181 provides a transporting power to transport the picked-up printing medium P to a position of a paper arranging device 190. The paper arranging device 190 arranges the printing medium P such that the toner image can be transferred to a desired portion of the printing medium P before the printing medium P passes between the photo-sensitive member 130 and the transfer roller 170.

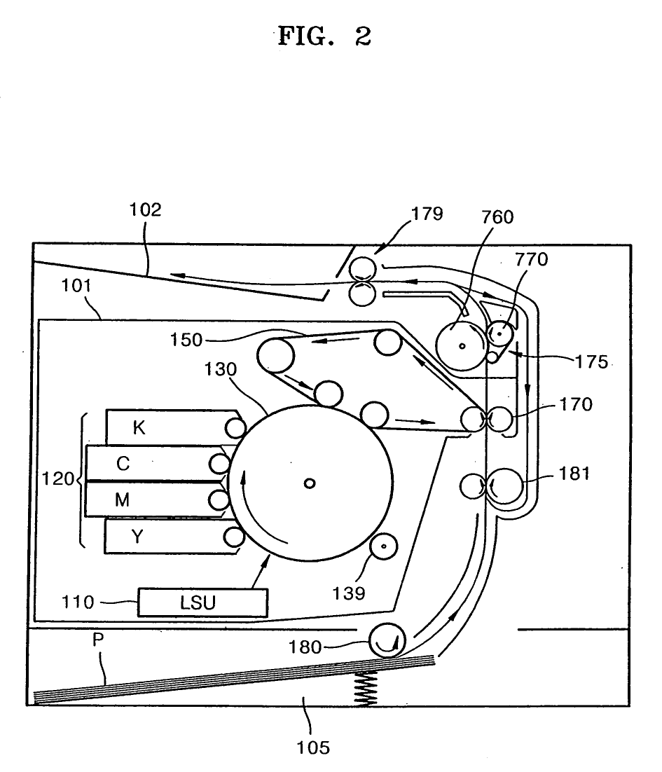

FIG. 2 illustrates an electrophotographic type image forming apparatus for color printing according to an embodiment of the present general inventive concept. Since the image forming apparatus of FIG. 2 includes similar components to the image forming apparatus of FIG. 1, a duplicated description with respect to the same reference numeral will be omitted, and a detailed description with respect to a printing operation will be also omitted. A plurality of developing cartridges 120 are needed to perform a color print using an electrophotographic method. The image forming apparatus of FIG. 2 may be a multi-pass type image forming apparatus and includes one photo-sensitive member 130 and four developing cartridges 120. The photosensitive member 130 is provided into the image forming apparatus main body 101 in addition to the developing cartridge 120.

The image forming apparatus of FIG. 2 may be a single-pass type image forming apparatus which includes four developing cartridges and four photo-sensitive members. The image forming apparatus of FIG. 2 may be a 2-pass type image forming apparatus which includes two units, each which has two developing cartridges and one photo-sensitive member. In various embodiments of the above-described single-color or color image forming apparatus, the photo-sensitive member 130 is provided to an inside of the developing cartridge 120 or to the image forming apparatus main body 101. The image forming apparatus of FIG. 2 may further include a transfer unit 150 having a transfer belt to transfer one or more toner images from the photo sensitive member 130 to the printing medium P. The developing cartridge 120, the photo-sensitive member 130, the transfer unit 150, and the transfer roller 170 may be referred to as an image forming unit to form the toner image on the printing medium P

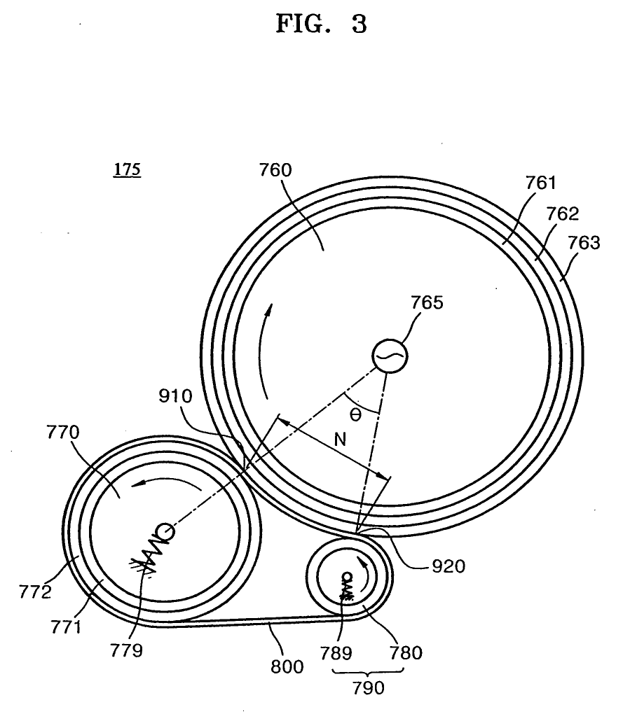

FIG. 3 is a side sectional view illustrating the fixing device 175 according to an embodiment of the present general inventive concept. The fixing device 175 includes a heating roller 760, a pressing roller 770, and a fixing belt 800. The fixing device 175 further includes an auxiliary pressing member 780 which presses the fixing belt 800 in addition to the pressing roller 770 to contact the heating roller 760. The auxiliary pressing member 780 maybe spaced-apart from the pressing roller 770 along the circumferential surface of the heating roller 760 as illustrated in FIG. 3.

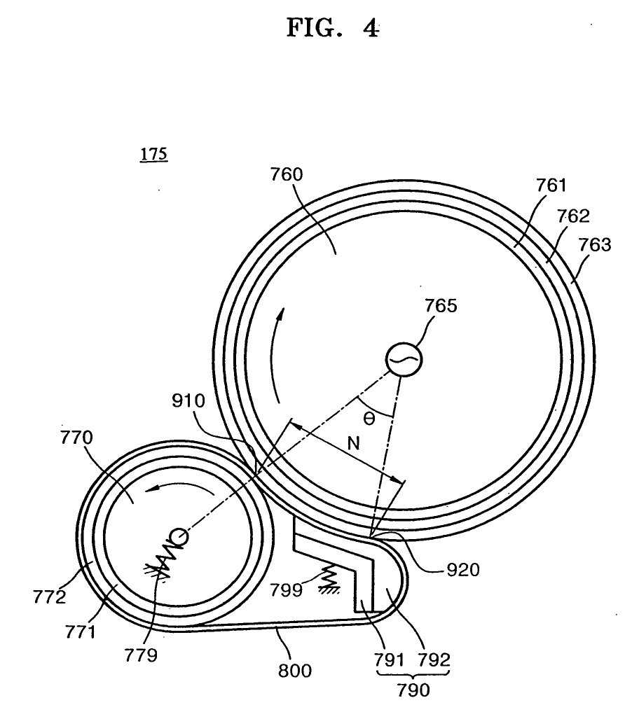

FIG. 4 is a side sectional view illustrating the fixing device 175 according to an embodiment of the present general inventive concept. An auxiliary pressing member 790 includes a supporting member 791 which is elastically biased in a direction of the fixing belt 800, and an elastic member 792 which is laminated on the supporting member 791 and slidingly supports the fixing belt 800

There is a need to heat a fixing nip N to a predetermined fixing temperature to fix the toner image before a start-up of the fixing. The heating roller 760 includes a heat source which generates a heat required for the fixing, a core pipe 761 heated by the heat source, and an elastic layer 762 which is provided to an outer circumference of the core pipe 761 to form the fixing nip N. As a material of the elastic layer 762, silicon rubber, fluoric rubber, or the like may be exemplified. As the heat source, a heating coil (not shown) which generates a joule heat, a halogen lamp 765, or the like may be exemplified. In the present embodiment, radiant energy generated by the halogen lamp 765 is converted into thermal energy on an opto-thermal converting layer provided to the inner circumference of the core pipe 761. The core pipe 761 is heated by the thermal energy, and a temperature of the elastic layer 762 laminated on the outer circumference of the core pipe 761 is raised up to the predetermined fixing temperature by thermal conduction.

A temperature control unit (not shown) to keep a constant fixing temperature is provided. A temperature sensing sensor (not shown) which is either contacting or not contacting an outer circumferential surface of the heating roller 760 for a temperature control is provided.

The pressing roller 770 is elastically biased by a spring member 779 and applies the predetermined fixing pressure to the fixing nip N. The toner image formed onto the printing medium P by the print unit is fused to the printing medium P while being heated at the predetermined fixing temperature and being pressed with the predetermined fixing pressure at the fixing nip N.

As described above, a warming-up time is needed to heat the fixing device 175 to the predetermined fixing temperature. To operate the image forming apparatus 100 at a high speed, it is necessary to shorten the warming-up time. The fixing device 175 of the present embodiment includes the core pipe 761 that is made thin to have a predetermined thickness or less to shorten a temperature-raising time. Thus, the thermal capacity of the thin core pipe 761 is reduced so that the temperature-raising time required to reach the predetermined fixing temperature is shortened. Therefore, the warming-up time of the image forming apparatus 100 is also shortened. However, because the mechanical strength of the thin core pipe 761 decreases as the thickness of the core pipe 761 is reduced, it is necessary to further strengthen the pipe core 761. The strength of the core pipe 761 may be reinforced through an aging treatment. As a material of which the mechanical strength may be reinforced through the aging treatment, alloy steel, maraging steel, an aluminum alloy, or the like may be exemplified.

Maraging is an aging treatment of a Martensite. The maraging steel may be Fe—Ni—Co—Mo-based alloy steel. The maraging steel has 18 to 25% nickel, a tensile strength of 175 to 210 kg/mm² and excellent toughness and workability. The maraging steel is classified into three kinds: nickel (18%)—cobalt (8%)—molybdenum steel (5%) (referred to as 18% nickel steel), nickel (20%)—titanium (1.5%)—niobium steel (0.45%) (referred to as 20% nickel steel), and nickel (25%)—titanium (1.5%)—niobium steel (0.45%) (referred to as 25% nickel steel). Among them, the 18% nickel steel has superior material characteristics and is most broadly used.

As an aluminum alloy of which strength can be reinforced through the aging treatment, a 2000-series aluminum alloy (Al—Cu, Al—Cu—Mg) (for example, Al 2011, Al 2014, Al 2017, and Al 2024), a 6000-series aluminum alloy (Al—Mg—Si) (for example, Al 6061 and Al 6063), a 7000-series aluminum alloy (Al—Zn—Mg—Cu) (for example, Al 7003 and Al 7075), or the like may be exemplified. The Zn, Mg, Cu, Si, or the like is an element which increases a mechanical characteristic of the aluminum.

There are various kinds of aging treatment methods to age-treat the core pipe 761. In one example, the core pipe 761 is aging-treated during a manufacturing process thereof to have a maximum strength. However, there is a time period in which the fixing device 175 is maintained at a high fixing temperature (for example, at 150 to 250° C. on a surface of the heating roller 760) during the life-span of the fixing device 175. Therefore, the core pipe 761 may not be aging-treated during the manufacturing process, but, rather, aging-treated at the fixing temperature when it is assembled to the image forming apparatus 100 and is used as the fixing device 175. Thus, the core pipe 761 may have the maximum strength through the aging treatment at the fixing temperature (for example, at about 150 to 250° C. on the surface of the heating roller 760) while it is assembled to the image forming apparatus 100 and is used as the fixing device 175, after it is undergone a minimum aging treatment during the manufacturing process. This heat treatment method can save a manufacturing process time and cost of the core pipe 761, as well as reinforcing the strength of the core pipe 761. Therefore, the fixing device 175 of the present embodiment includes the core pipe 761 of which strength increases while being aging-treated, according to the time used in the fixing device 175. The relationship between the strength and the aging treatment according to the material of the core pipe 761 will later be described.

The thickness of the core pipe 761 may be 1 mm or less. Thus, the thickness of the core pipe 761 is very small, so that it is possible to realize the rapid temperature-raising thereof. Further, since the core pipe 761 is aging-treated while being maintained at a high fixing temperature, the mechanical strength thereof is reinforced even though the core pipe 761 is thin, whereby it is possible to prevent the dimensional stability or the durability of the core pipe 761 from decreasing.

As illustrated in FIGS. 3 and 4, the heating roller 760 may further include a release layer 763 provided at an outer circumference of the elastic layer 762 to prevent the toner image from remaining on the heating roller 760. As a material of the release layer 763, fluoric rubber, silicon rubber, fluoric resin, or the like may be exemplified.

To shorten the temperature-raising time taken to reach the fixing temperature and to improve a fixing characteristic, a heating source (not shown) may be provided at the inner circumference of the pressing roller 770. As an embodiment in which a thermal capacity of the pressing roller 770 including the heat source decreases, the pressing roller 770 may include the metallic core pipe 771 and the elastic layer 772 laminated thereon. The detailed description of the metallic core pipe 771 and the elastic layer 772 of the pressing roller 770 has been described above.

As the print speed increases, a stay time of the printing medium P on the fixing nip N decreases, so that a print quality deteriorates. The fixing nip N is enlarged to increase the stay time on the fixing nip N. It is possible to enlarge the fixing nip N by extending outer diameters of the heating and pressing rollers 760 and 770 or by increasing a thickness of the elastic layer 762 which forms the fixing nip N while being elastically deformed. However, the extension in the outer diameter of the rollers may cause an obstruction when it is needed to make the image forming apparatus 100 small, the warming-up time is lengthened due to the increase in the thermal capacity thereof, and a material cost increases. The increase in the thickness of the elastic layer 762 may increase the warming-up time due to the increase in the thermal capacity thereof. The core pipe 761 must be heated at a higher temperature than in a case where the elastic layer 762 is thin. This may cause the high temperature deterioration and the decrease in durability at an adhesion portion between the elastic layer 762 and the core pipe 761, or the elastic layer 762 itself. The warming-up becomes fast due to a decrease in the outer diameters of the heating roller 760 and the pressing roller 770 and the thickness of the elastic layer 762, but which may cause a decrease in the fixing nip N and the deterioration in fixing quality. The improvement in the fixing characteristics may result in a decrease in the fixing speed, so that it is important to satisfy these at the same time. According to the present embodiment, the core pipe 761 is made to be thin, so that the warming-up time is shortened, and at the same time, the fixing belt 800 is provided to improve the fixing characteristics through the extension in the fixing nip N.

Referring to FIG. 4, the fixing device 175 further includes the auxiliary pressing member 790 which presses the fixing belt 800 and brings the fixing belt 800 in contact with the heating roller 760, in addition to the pressing roller 770. The fixing nip N is formed between a first contact point 910 at which the heating roller 760 and the pressing roller 770 contact each other, and a second contact point 920 at which the heating roller 760 and the auxiliary pressing member 790 contact each other. A contact angle between the first and second contact points 910 and 920 is denoted by a reference numeral θ, and a length of the fixing nip N formed therebetween is denoted by a reference numeral N.

As illustrated in FIG. 3, the auxiliary pressing member 790 includes the auxiliary pressing roller 780 which is elastically biased in a direction of the fixing belt 800 and supports the fixing belt 800 while rotating. The auxiliary pressing roller 780 is elastically biased in the direction of the fixing belt 800 by a spring member 789 with respect to the image forming apparatus main body 101 of FIGS. 1 and 2, and presses the fixing belt 800 in a direction of an outer circumferential surface of the heating roller 760, thereby bringing the fixing belt 800 into contact the heating roller 760 at the second contact point 920.

As illustrated in FIG. 4, the auxiliary pressing member 790 includes the supporting member 791 which is elastically biased in a direction of the fixing belt 800, and the elastic member 792 which is laminated on the supporting member 791 and slidingly supports the fixing belt 800. The supporting member 791 is elastically biased with respect to the main body 101 with a spring 799 interposed therebetween. The supporting member 791 is made of a material with superior rigidity. The elastic member 792 frictionally contacts the inner circumferential surface of the fixing belt 800 and slidingly supports the fixing belt 800. As a material of the elastic member 792, silicon rubber, urethane, foamed resin, or the like may be exemplified. It is possible that the surface of the elastic member 792 is further provided with a coating layer (not shown) made of a fluoric resin or the like to reduce a frictional resistance when it slidingly supports the inner circumferential surface of the fixing belt 800.

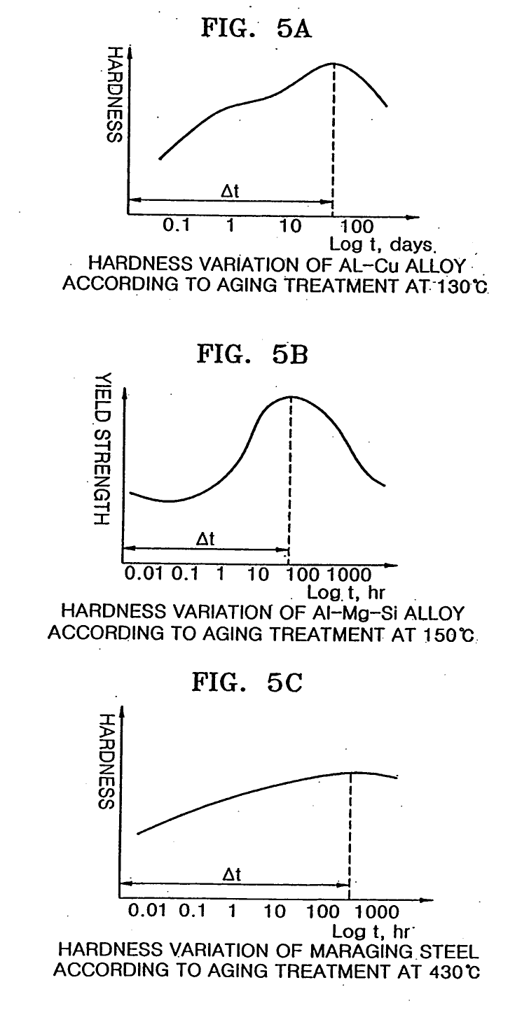

FIGS. 5A to 5C are graphs illustrating a relationship between the aging-treatment and the strength of the material of the core pipe 761 according to an embodiment of the present general inventive concept. A horizontal axis illustrates an aging treatment time as a log scale, and a vertical axis illustrates a hardness of the core pipe 761. FIG. 5A illustrates a hardness variation according to the aging treatment when an Al—Cu alloy is left at 130° C. FIG. 5B illustrates the hardness variation according to the aging treatment when an Al—Mg—Si alloy is left at 150° C. FIG. 5C illustrates the hardness variation according to the aging treatment when maraging steel is left at 430° C. Reference numeral Δt illustrates the aging treatment time taken until the hardness reaches a maximum value. A position of the reference numeral Δt is changed according to the material and the heating treatment condition. The material of the core pipe 761 may be selected such that the life-span of the fixing device 175 is as long as the aging treatment time until the hardness reaches the maximum value of reference numeral Δt.

As described above, the fixing device and the image forming apparatus including the fixing device of the present general inventive concept can provide the following effects.

First, the core pipe may be made to be thin, so that the temperature-raising time can be shortened, whereby the warming-up time of the image forming apparatus is shortened and a high speed printing can be realized.

Second, the mechanical strength of the thin core pipe may increase through the aging treatment, so that the dimensional stability and the fixing quality can be secured.

Third, the aging treatment may be performed during the normal use of the fixing device, so that time and cost required for the manufacturing process can be reduced.

Fourth, the fixing nip may be enlarged due to the provision of the fixing belt, so that the printing quality becomes stable even during high speed printing in which the high fixing quality is required. Further, the size of the fixing device may be reduced, so that the image forming apparatus can be manufactured in a small size. Further, the stay time of the printing medium in the fixing nip may increase, so that the fixing temperature can be set relatively low, whereby the high temperature deterioration at the adhesion portion between the elastic layer and the core pipe or the elastic layer itself can be prevented and the warming-up time can be shortened.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fixing device of an electrophotographic type image forming apparatus, comprising:
a heat source to generate heat to fuse a toner image adhering to a printing medium;
a heating roller comprising:
a core pipe heated by the heat source, and an elastic layer provided to an outer circumference of the core pipe; and
a pressing roller to press the printing medium to the outer circumferential surface of the heating roller,
wherein the core pipe is aging-treated at a fixing temperature while being used for the fixing device, so that a strength thereof increases.

2. The fixing device according to claim 1, wherein a material of the core pipe is any one of maraging steel, a 2000-series aluminum alloy, a 6000-series aluminum alloy, and a 7000-series aluminum alloy.

3. The fixing device according to claim 1, wherein a thickness of the core pipe is 1 mm or less.

4. The fixing device according to claim 1, wherein the heating roller further comprises a release layer provided to an outer circumference of the elastic layer to prevent the toner image from adhering to the heating roller.

5. The fixing device according to claim 1, further comprising:
a fixing belt which is pressed by the pressing roller to form a fixing nip together with the outer circumferential surface of the heating roller, and to move in circulation.

6. The fixing device according to claim 5, further comprising:
an auxiliary pressing member to press the fixing belt together with the pressing roller to bring the fixing belt in contact with the heating roller.

7. The fixing device according to claim 6, wherein the auxiliary pressing member comprises:
a supporting member which is elastically biased in a direction of the fixing belt; and
an elastic member which is laminated on the supporting member to slidingly support the fixing belt.

8. The fixing device according to claim 6, wherein the auxiliary pressing member further comprises an auxiliary pressing roller which is elastically biased in a direction of the fixing belt to support the fixing belt while rotating.

9. An electrophotographic type image forming apparatus having a print unit to attach a toner image to a printing medium through an electrophotographic method, and a fixing device to fuse the toner image to the printing medium, wherein the fixing device comprises:
a heat source to generate heat to fuse a toner image adhered to a printing medium;
a heating roller including a core pipe heated by the heat source, and an elastic layer provided to an outer circumference of the core pipe; and
a pressing roller to press the printing medium to the outer circumferential surface of the heating roller,
wherein the core pipe is aging-treated at a fixing temperature while used for the fixing device, so that a strength thereof increases.

10. The electrophotographic type image forming apparatus according to claim 9, wherein a material of the core pipe is one of a maraging steel, a 2000-series aluminum alloy, a 6000-series aluminum alloy, and a 7000-series aluminum alloy.

11. The electrophotographic type image forming apparatus according to claim 9, wherein a thickness of the core pipe is 1 mm or less.

12. The electrophotographic type image forming apparatus according to claim 9, wherein the fixing roller further comprises a release layer provided to an outer circumference of the elastic layer to prevent the toner image from adhering to the heating roller.

13. The electrophotographic type image forming apparatus according to claim 9, the fixing device further comprises a fixing belt which is pressed by the pressing roller, to form a fixing nip together with the outer circumferential surface of the heating roller, and to move in circulation.

14. The electrophotographic type image forming apparatus according to claim 13, wherein the fixing device further comprises an auxiliary pressing member to press the fixing belt together with the pressing roller to make the fixing belt contact the heating roller.

15. The electrophotographic type image forming apparatus according to claim 14, wherein the auxiliary pressing member includes:
a supporting member which is elastically biased in the direction of the fixing belt; and
an elastic member which is laminated on the supporting member to slidingly support the fixing belt.

16. The electrophotographic type image forming apparatus according to claim 14, wherein the auxiliary pressing member further comprises an auxiliary pressing roller which is elastically biased in the direction of the fixing belt to support the fixing belt while rotating.

17. An electrophotographic type image forming apparatus, comprising:
a developing cartridge;
a photo-sensitive member; and a fixing device including a heating roller formed with a core pipe having a material to undergo heat treatment at a work temperature of the image forming apparatus.

18. A method of hardening a core pipe of a heating roller in an image forming apparatus, the method comprising:
heating the heating roller to a work temperature where a hardening temperature of a core pipe material approximates the work temperature.

19. An image forming apparatus, comprising:
a main body;
an image forming unit disposed in the main body to form an image on a printing medium; and
a fixing device having a heating roller to generate heat to fuse the image on the printing medium and to be age-treated by the generated heat.

20. The image forming apparatus according to claim 19, wherein the core pipe has a first minimum age-treatment before a first use of the image forming apparatus and a second minimum age-treatment when the image forming apparatus is used.
